(19) United States
(12) Patent Application Publication
(10) Pub. No.: US 2014/0173366 A1
(43) Pub. Date: Jun. 19, 2014

(54) TRANSMITTING A DIAGNOSTIC CODE FROM A PROCESSOR

(71) Applicants: Mark L Hammons, Magnolia, TX (US); Jamison K. Bartz, Magnolia, TX (US)

(72) Inventors: Mark L Hammons, Magnolia, TX (US); Jamison K. Bartz, Magnolia, TX (US)

(21) Appl. No.: 14/232,003

(22) PCT Filed: Jul. 29, 2011
(86) PCT No.: PCT/US2011/045990

§ 371 Date: Jan. 10, 2014

(51) Int. Cl. G06F 11/07

(52) U.S. Cl. CPC G06F 11/0787
USPC 714/48

(57) ABSTRACT

Diagnostic codes are transmitted by a processor using an access operation to a storage or memory device. In some configurations, the diagnostic codes are inferred by observing access operations to the storage or memory device.

### BACKGROUND

In the art of computing, diagnostic codes are transmitted From processors. In some configurations, diagnostic codes are transmitted using relatively low-level mechanisms that allow codes to be transmitted without reliance on other components of the computer system, such as display devices or network interfaces.

### BRIEF DESCRIPTION OF THE DRAWINGS

The Figures depict examples, implementations, and configurations of the invention, and not the invention itself.

FIG. 1 shows a computer system that includes an example configuration for sending diagnostic codes.

FIG. 2 shows an I/O hub, a system firmware EEPROM, and a diagnostic code capture module of FIG. 1 in greater detail.

FIGS. 3, 4, 5, and 6 are flowcharts showing example methods.

### DETAILED DESCRIPTION

In the foregoing description, numerous details are set forth to provide an understanding of the examples disclosed herein. However, it will be understood by those skilled in the art that the examples ma be practiced without these details. While a limited number of examples have been disclosed, those skilled in the art. will appreciate numerous modifications and variations therefrom. It is intended that the appended claims cover such modifications and variations as fall within the true spirit and scope of the examples.

The examples provided herein relate to a method of outputting diagnostic codes. The various diagnostic codes are associated with access operations performed to a storage device, and a diagnostic code capture module monitors access operations performed between a processor and the storage device and infers transmitted diagnostic codes from the monitored. access operations.

In the art of computing, input and output (I/O) operations are performed using a variety of methods. One method provided by ×86 processors produced by Intel Corporation, Advanced Micro Devices, Incorporated, and other vendors, is port-mapped I/O. In contrast to memory-mapped I/O, which shares a common address space with memory, port-mapped I/O has a separate address space reserved for I/O operations. Two ×86 instructions that utilize port-mapped I/O are the IN and OUT instructions.

As initialization of a computer system begins, typically various ISO devices have not been initialized. However, there is a still a desire to observe diagnostic codes as the computer system is initialized, which typically comprises executing boot code from system firmware stored in an electrically erasable programmable read-only memory (EEPROM). From the early days of ×86 computers, diagnostic codes have been transmitted by sending the codes to ports, such as ports 80, 84, and 85.

Such diagnostic codes continue to he used in modem computer system. For example, a ProLiant DL580 server, which is a product of Hewlett-Packard Corporation, can output diagnostic codes using Port 85. Codes having a format of 3×h indicate processor-related errors, codes having a format of 4×h indicate memory-related errors, and codes having a format of 6×h indicate expansion board-related errors. Additional codes are also defined.

Early ×86 computers typically had an Industry Standard Architecture (ISA) bus, and a diagnostic display/capture card could be inserted into an ISA slot to capture or display diagnostic codes transmitted via I/O port access instruction. Similar functionality was achieved using the Peripheral Component Interconnect (PCI) buses found on later computers. ISA and PCI buses are parallel buses that provide access to the port addressing space, so diagnostic codes transmitted via port addresses may be observed at any PCI or ISA slot.

More recently, ISA and PCI buses are being replaced by Peripheral Component Interconnect Express (PCIe) buses. PCIe buses are not well suited for outputting diagnostic codes using port addresses for several reasons. First, often the PCIe topology is not initialized when a computer system begins initialization, and accordingly it may not be possible to output a diagnostic code to an uninitialized PCIe channel. Second, PCIe is a point-to-point protocol that includes a routing component. While port-mapped transactions may typically be observed at all ISA and PCI slots, a PCIe channel must be configured to route the port-mapped transactions to at particular PCIe slot.

In 1998 Intel Corporation introduced the Low Pin Count (LPC) bus to support low-bandwidth devices, such as an interface to system firmware, and ISO devices such as serial and parallel ports, keyboards, mice, floppy disk controller, and the like. To software executing on a computer system, the UPC bus resembles and ISA bus, and the LPC bus helped facilitate the removal of ISA buses from computer systems while still supporting legacy devices designed to operate using ISA buses.

The LPC bus continues to be popular in modern computer systems, and the LPC bus provides an excellent observation point for monitoring diagnostic codes transmitted from the processor. Furthermore, the LPC bus is functional and exposes diagnostic codes as soon as the processor begins the initialization process.

While the LPC bus is still often provided in many modem computer systems, it is anticipated that the LPC bus will be eventually phased out. It is also anticipated that future computer systems will no longer contain buses that facilitate observation of codes transmitted by a processor using port-mapped I/O.

Examples disclosed herein provide for diagnostic codes to be observed from a bus that is easily monitored and is functional when a computer system begins initialization. The bus discussed in the examples below is the bus between the processor and the storage device that stores system firmware. Since firmware must be read when the processor is initialized (e.g., after a power on sequence or after a reset sequence), the bus coupled to the device that stores the firmware is typically available. Rather than using port-mapped I/O, the examples disclosed herein use access operations to the storage device to represent diagnostic codes, as will be described in greater detail below.

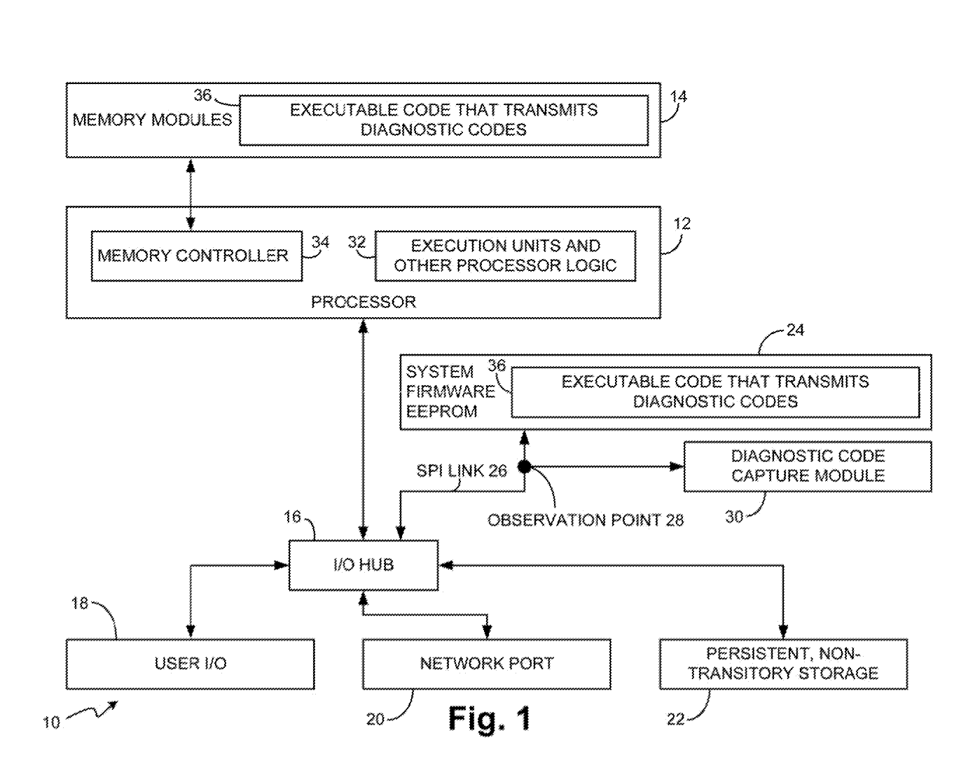

FIG. 1 shows computer system 10 that includes an example configuration for sending diagnostic codes. Computer system 10 includes processor 12, memory modules 14, I/O hub 16, user I/O 18, network port 20, persistent, non-transitory storage 22, system firmware EEPROM 24, Serial Peripheral Interface (SPI) link 26, observation point 28, and diagnostic code capture module 30.

Processor 12 includes execution units and other processor logic 32, and memory controller 34. Note that there has been a trend to integrate memory controllers into processors, with the processors providing the various signals required to access memory modules. Memory controller 34 is coupled to memory modules 14, which may store executable code 36 that transmits diagnostic codes. Note that in FIG. 1, code 30 is also stored in system firmware EEPROM 24. In one example, memory modules 14 comprise dynamic random access memory (DRAM) used to store code and data during execution, and EEPROM 24 provides persistent storage that stores code 36 when computer system 10 is powered down.

I/O hub 16 is coupled to user I/O 18, which represents all user I/O, such as input devices, display devices, audio devices, various ports (such as USB ports) and the like, I/O hub 16 is also coupled to network port 20, which couples computer system 10 to a network, and persistent, non-transitory storage 22, which stores program code and data.

Recently, SPI interfaces have been deployed as the primary interface for coupling a system firmware EEPROM to a processor. For example, I/O hubs provided as part of Intel Series 5 chipsets include a dedicated SPI flash port that may be coupled to a system firmware EEPROM. The SPI link is configured and active during initialization since one of the first tasks that must be performed is to read boot code stored in the EEPROM.

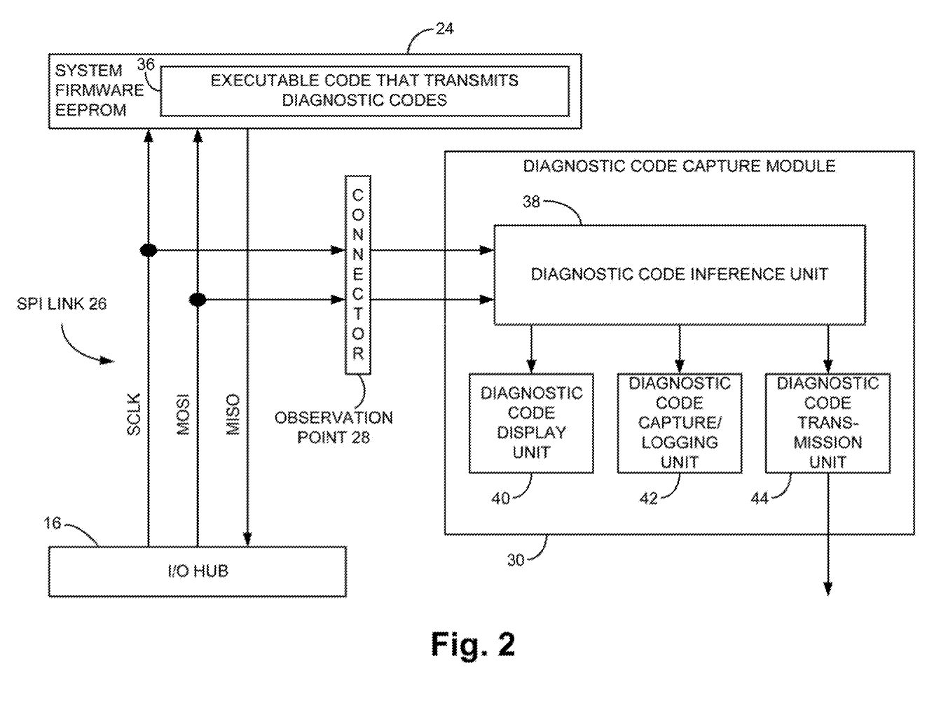

FIG. 2 shows I/O hub 16, system firmware EEPROM 24, and diagnostic code capture module 30 of FIG. 1 in greater detail. SPI link 26 is also shown in greater detail. One master device and multiple slave devices may be coupled to an SPI bus. In FIG. 2, I/O hub 16 is a master device.

An SPI bus may consist of four wires. However, one of the wires is at “Slave Select” which allows a master device to select a slave device for communication, and if an SPI bus is only used for communication between a pair of devices, the “Slave Select” may be tied to an active state. The remaining signals are “Serial Clock” (SCLK), “Master Output, Slave Input” (MOSI), and “Master Input, Slave Output” (MISO). To monitor memory access transactions from processor 12 of FIG. 2, only the SCLK and MOSI signals need to be monitored. However, in other configurations, it may he desirable to also monitor the MISO signal. For example, data returned by EEPROM 24 could be verified by diagnostic code capture module 30 against a second copy of code 36 to ensure the integrity of data being provided by EEPROM 24.

The SCLK and MOSI signals are provided to observation point 28, which may comprise as connector, as shown in FIG. 2. Also coupled to observation point 28 is diagnostic code capture module 30. Module 30 may be provided as a standalone diagnostic device that a technician couples to observation point 28 to read diagnostic codes, or module 30 may be integrated into computer system 10 of FIG. 1.

Module 30 includes diagnostic code inference unit 38, which monitors the SCLK and MOSI signals and infers diagnostic codes my monitoring transactions carried by these signals. After unit 38 identifies a diagnostic code transmitted by processor 12 of FIG. 1, module 30 may display the diagnostic code using diagnostic code display unit 40, may capture or log the diagnostic code using diagnostic code capture/logging unit 42, or transmit the code elsewhere using diagnostic code transmission unit 44. in a configuration Where module 30 is integrated into computer system 10, it may be desirable to transmit diagnostic codes to a baseband management controller, service processor, or similar management device.

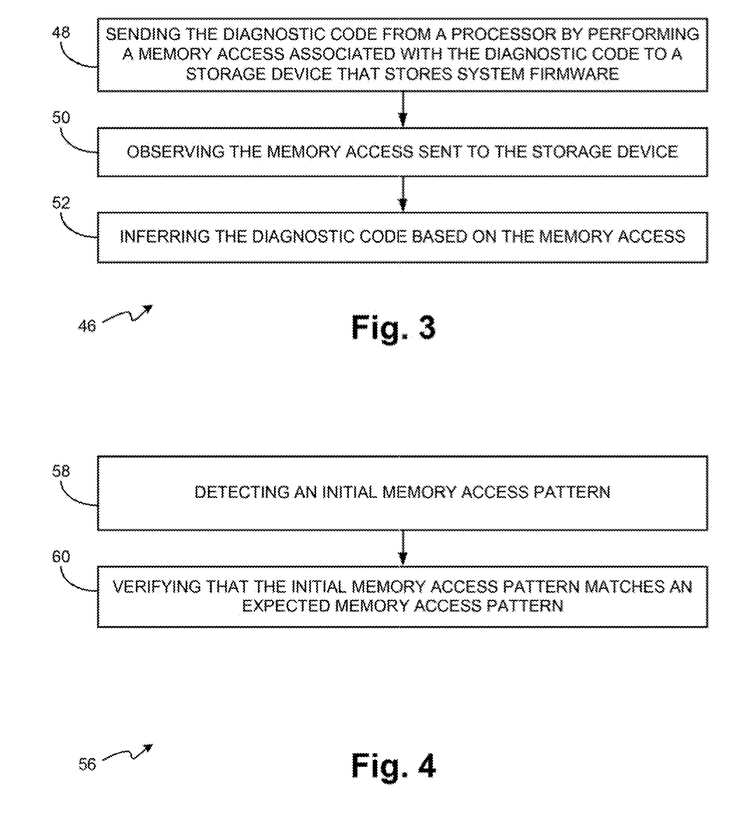

FIG. 3 shows as flowchart 46 that illustrates an example method. At block 48, processor 12 transmits a diagnostic code by performing a memory access operation to EEPROM 24. Control passes to block 50, where module 30 observes the memory access operation via the connection to SPI link 26 through observation point 28. Control passes to block 52, where diagnostic code inference unit 38 of module 30 infers the diagnostic code from the memory access operation.

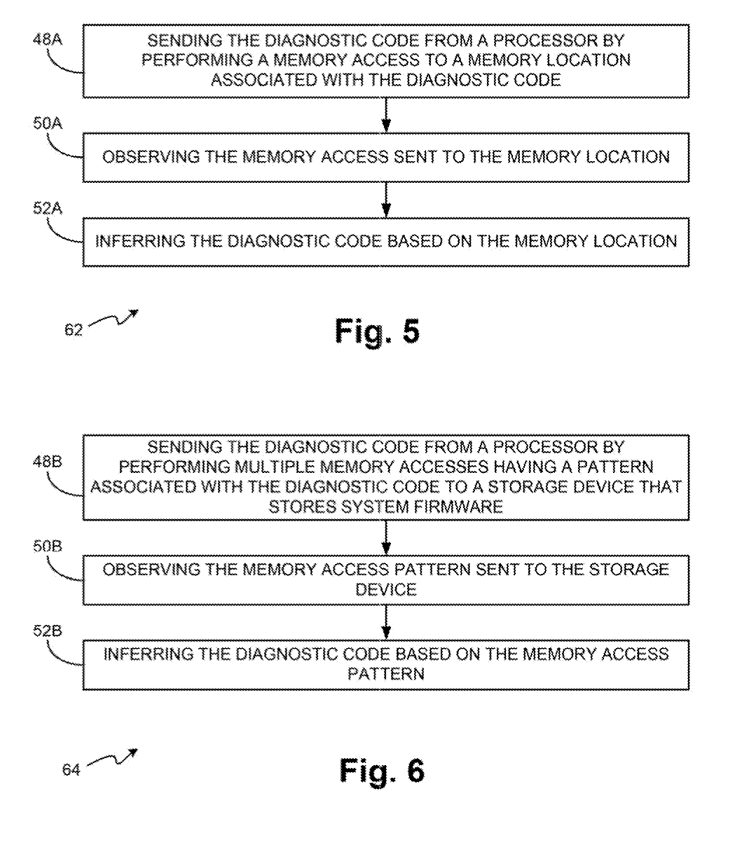

Additional options for encoding diagnostic codes using memory access operations are discussed below with reference to FIGS. 5 and 6. However, before discussing how diagnostic codes are encoded, first consider an additional diagnostic opportunity provided by the examples shown in FIGS. 1 and 2 When computer system 10 is initialized, processor 12 will seek to read boot code from EEPROM 24. In general, the memory access patterns should be identical each time computer system 10 is initialized up until a branch point that branches based on a particular difference in configuration or condition. For example, the code executed could be identical until memory is initialized, with different code being executed based on the type and amount of memory installed. Diagnostic code capture module can monitor the memory transactions that occur immediately after initialization and verify that the transactions are correct.

FIG. 4 shows a flowchart 56 illustrating this example. In block 58, module 30 detects the initial memory access pattern, and control passes to block 60. At block 60, diagnostic code inference unit 60 verifies that the initial memory access patterns match an expected memory access pattern. In essence, the initial memory access pattern after initialization may be used to generate a diagnostic code, even though processor 12 did not explicitly transmit a diagnostic code.

Note that diagnostic code capture module 30 may be provided with an initialization signal, such as a reset sequence of SPI link or an independent signal not shown in FIG. 2. Furthermore, module 30 may be provided with a copy of the initial memory access patterns based on code 36, or may undergo a training operation where memory access patterns are captured by module 30 during normal operation.

Returning to encoding diagnostic codes in memory transactions, FIG. 5 shows a flowchart 62 that encodes diagnostic codes using allocated memory locations. At block 48A, processor 12 sends a diagnostic code by performing a memory access operation to a memory location associated with the diagnostic code, and control passes to block 50A. At block 50A, module 30 observes the memory access operation, and control passes to block 52A where diagnostic code inference unit 38 infers the diagnostic code from the memory access operation.

Since diagnostic codes have defined associations with memory access operations, the memory locations used to encode diagnostic codes should not be used for other purposes. One way to achieve this is to define a memory range for diagnostic codes outside the range used to store code 36 in EEPROM 24. Note that the memory access operation needs to be visible at observation point 28, and caching in I/O hub 16 or processor 12 may prevent the memory access operations from being visible. One way to address this issue is to mark the address range used for diagnostic code associations as uncacheable. Another way to address this issue is to clear all caches which may be caching data from EEPROM 24 before transmitting a diagnostic code.

Also note that prefetching operations of processor 12 or I/O hub 16 may affect diagnostic code assignments. For example, if a read to a single memory location always results in reading 256 bytes, memory locations corresponding to diagnostic codes should he spaced at least 256 bytes apart in memory. For example, a read from memory location 0×FFFF_{—}0000 could be interpreted as a legacy I/O mapped write of ×00 to port 0×84, and a memory read from location 0×FFFF_{—}0100 could be interpreted as a legacy I/O mapped write of 0×01 to port 0×84.

FIG. 6 is a flowchart 64 that shows an example method of encoding diagnostic codes using memory access patterns. At block 48B, the processor sends a diagnostic code by sending multiple memory access operations having a pattern associated with the diagnostic code. As discussed above, the transactions need to be observable, so it may be necessary to mark some locations as uncacheable, or clear caches before transmitting diagnostic codes. Control passes to block 50B. At block 50B, module 30 observes memory access patterns, and control passes to block 52B. At block 52B, unit 38 infers diagnostic codes based on the memory access patterns.

Note that it is not necessary to reserve is separate address range for creating assignments between patterns and diagnostic codes. All that is necessary is that the access pattern be a pattern that would not occur during normal operation. For example, normally processor 12 would not read a single memory location multiple times. Similarly, normally processor 12 would not read a series of memory locations in reverse program order, or a series of unrelated memory locations. By associating unique access patterns with diagnostic codes, processor 12 may transmit diagnostic codes to module 30 without reserving a dedicated address range.

The examples above illustrate how prior art diagnostic code transmission techniques can be adapted to support emerging computer architectures that do not have legacy buses. Existing firmware routines are easily modified by searching for code segments that transmit diagnostic codes using port-mapped I/O, and replacing those code segments with code segments that perform memory access operations to the system firmware EEPROM, as described above. Furthermore, only two SPI signals need to be monitored, so the examples discussed above minimize connector costs and pin counts.

In the foregoing description, numerous details are set forth to provide an understanding of the examples disclosed herein. However, it will be understood by those skilled in the art that the examples may be practiced without these details. While as limited number of examples have been disclosed, those skilled in the art will appreciate numerous modifications and variations therefrom. It is intended that the appended claims cover such modifications and variations as fall within the true spirit and scope of the disclosed examples.

What is claimed is:

1. A method (46, 62, 64) of outputting a diagnostic code comprising:
sending (48, 48A, 48B) the diagnostic code from a processor by performing a memory access associated with the diagnostic code to a storage device that stores system firmware;
observing (50, 50A, 50B) the memory access sent to the storage device; and
inferring (52, 52A, 52B) the diagnostic code based on the memory access.

2. The method (46, 62, 64) of claim 1 wherein the processor and the storage device are coupled via a Serial Peripheral Interface (SPI) bus, and observing (50, 50A, 50B) the memory access sent to the storage device comprises:
snooping the SPI bus.

3. The method (46, 62) of claim 1 wherein memory regions of the storage device are reserved for associations with diagnostic codes, and sending (48, 48A) the diagnostic code from a processor by performing is memory access associated with the diagnostic code to a storage device that stores system firmware comprises performing (48A) a memory access to memory location associated with the diagnostic code, and observing (50, 50A) the memory access sent to the storage device and inferring (52, 52A) the diagnostic code based on the memory access comprise observing (50A, 52A) the memory access to the memory location.

4. The method (46, 64) of claim 1 wherein memory access patterns are associated with diagnostic codes, and sending (48, 48B) the diagnostic code from a processor by performing a memory access associated with the diagnostic code to as storage device that stores system firmware comprises performing (48B) multiple memory accesses having, as pattern associated with the diagnostic code, and observing (50, 50B) the memory access sent to the storage device and inferring (52. 52B) the diagnostic code based on the memory access comprise detecting (50B, 52B) the multiple memory accesses baying a pattern associated with the diagnostic code.

5. The method (46) of claim 1 and further comprising:
detecting (58) an initial memory access pattern; and
verifying (60) that the initial memory access pattern matches an expected memory access pattern.

6. A computer system (10) comprising:
a processor (12);
persistent non-transitory storage (24) coupled to the processor (12);
a data link (26) coupling the processor (12) and the persistent non-transitory storage (24);
an observation point (28) associated with the data link (26); and
system memory (14) coupled to the processor (12), wherein code (36) executed by the processor (12) from system memory (14) transmits diagnostic codes by issuing storage transactions to the persistent non-transitory storage (24), with the diagnostic codes being inferable by monitoring storage transactions at the observation point (28).

7. The computer system (10) of claim 6 wherein the persistent non-transitory storage (24) stores system firmware, including a copy of the code (36) executed by the processor (12) that transmits the diagnostic codes.

8. The computer system (10) of claim 6 wherein the observation point (28) is a connector (28) that allows a monitoring device (30) to snoop transactions on the data link (26).

9. The computer (10) system of claim 8 wherein the data link (26) comprises Serial Peripheral Interface (SPI) bus.

10. The computer system (10) of claim 6 wherein diagnostic codes are represented by storage transaction patterns.

11. A non-transitory computer-readable medium (24) tangibly storing computer executable instructions which, when executed by a processor (12), cause the processor (12) to perform:
sending (48, 48A, 48B) diagnostic codes from the processor (12) by performing memory read transactions, wherein unique diagnostic codes are represented by addresses of the memory read transactions.

12. The non-transitory computer-readable medium (24) of claim 11 wherein the non-transitory computer-readable medium is a target of the memory read transactions.

13. The non-transitory computer-readable medium (24) of claim 11 wherein an address range is reserved for associating memory read transaction addresses with diagnostic codes.

14. The non-transitory computer-readable medium (24) of claim 11 wherein diagnostic codes are encoded as memory read transaction patterns.

15. The non-transitory computer-readable medium (24) of claim 11 wherein the memory read transactions are issued over as Serial Peripheral Interface (SPI) bus.
